(19) United States
(12) Patent Application Publication
(10) Pub. No.: US 2019/0192363 A1
(43) Pub. Date: Jun. 27, 2019

(54) Wheelchair Power Supply System

(71) Applicants: Suzanne Mower, Hughesville, MD (US); Chrystal Sterling, Hughesville, MD (US)

(72) Inventors: Suzanne Mower, Hughesville, MD (US); Chrystal Sterling, Hughesville, MD (US)

(21) Appl. No.: 15/849,934

(22) Filed: Dec. 21, 2017

(51) Int. Cl. A61G 5/12; H02J 7/00; H02J 7/02; H02J 5/00; B62D 11/04

(52) U.S. Cl. CPC A61G 5/125; H02J 7/0042; H02J 7/0027; H02J 7/355; H02J 5/00; B62D 11/04; H02J 7/0055; H02J 7/02

(57) ABSTRACT

A wheelchair power supply system for providing backup power for an electric wheelchair includes an electric wheelchair has an armrest. A pouch is suspended from the armrest and the pouch has a plurality of apertures extending into an interior of the pouch. A power supply is positioned in the pouch and the power supply has a charge port for charging the power supply. The power supply has a plurality of outputs and each of the outputs is selectively and electrically coupled to an electronic device for charging. Moreover, the electric wheelchair is selectively and electrically coupled to one of the outputs such that the power supply serves as a backup power source for the electric wheelchair.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to power supply devices and more particularly pertains to a new power supply device that serves as a backup power supply for an electric wheelchair.

### BRIEF SUMMARY OF THE INVENTION

An embodiment of the disclosure meets the needs presented above by generally comprising an electric wheelchair has an armrest. A pouch is suspended from the armrest and the pouch has a plurality of apertures extending into an interior of the pouch. A power supply is positioned in the pouch and the power supply has a charge port for charging the power supply. The power supply has a plurality of outputs and each of the outputs is selectively and electrically coupled to an electronic device for charging. Moreover, the electric wheelchair is selectively and electrically coupled to one of the outputs such that the power supply serves as a backup power source for the electric wheelchair.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a wheelchair power supply system according to an embodiment of the disclosure.

FIG. 2 is a bottom phantom view of a pouch of an embodiment of the disclosure.

FIG. 3 is a left side view of a power supply of an embodiment of the disclosure.

FIG. 4 is a front view of a power supply of an embodiment of the disclosure.

FIG. 5 is a perspective in-use view of an embodiment of the disclosure.

### DETAILED DESCRIPTION OF THE INVENTION

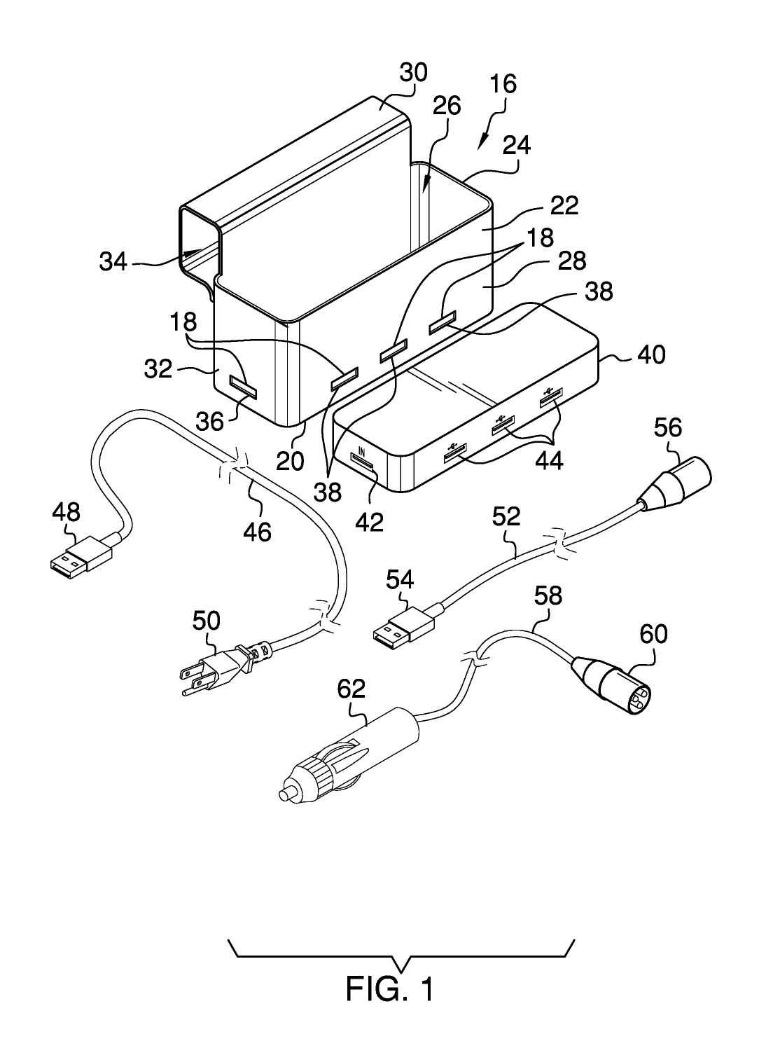

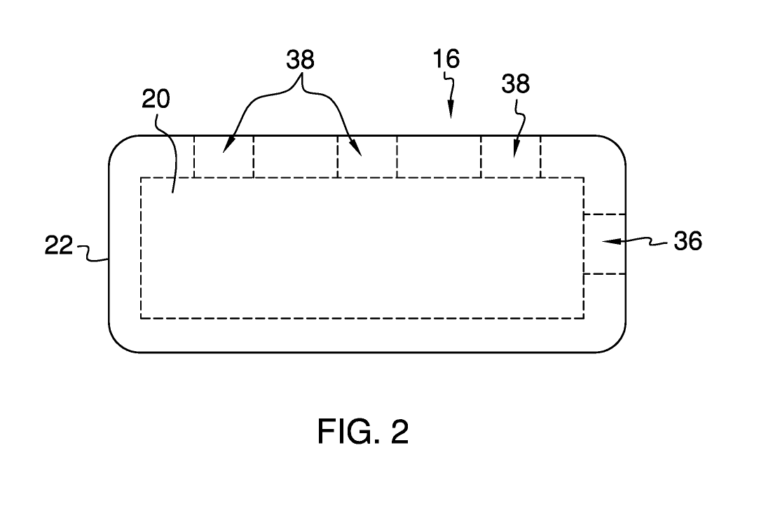

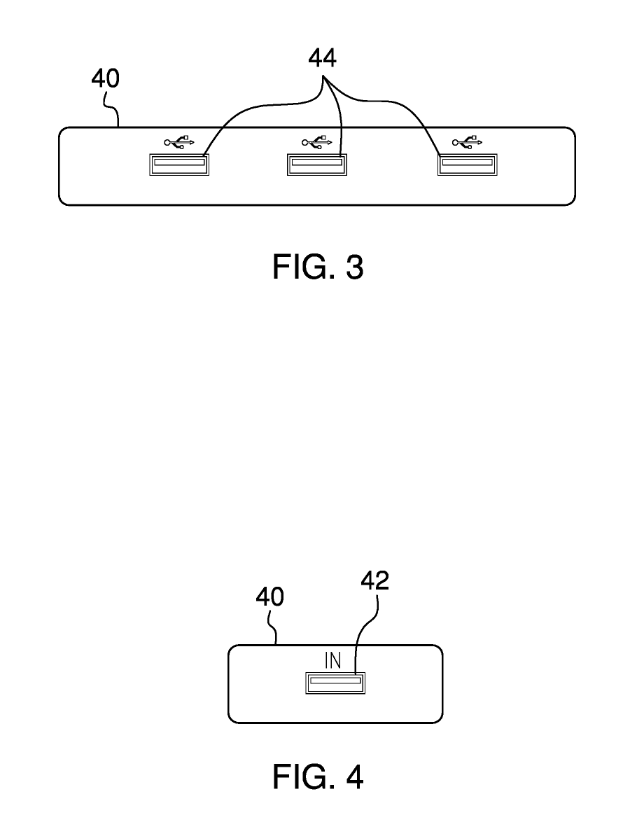

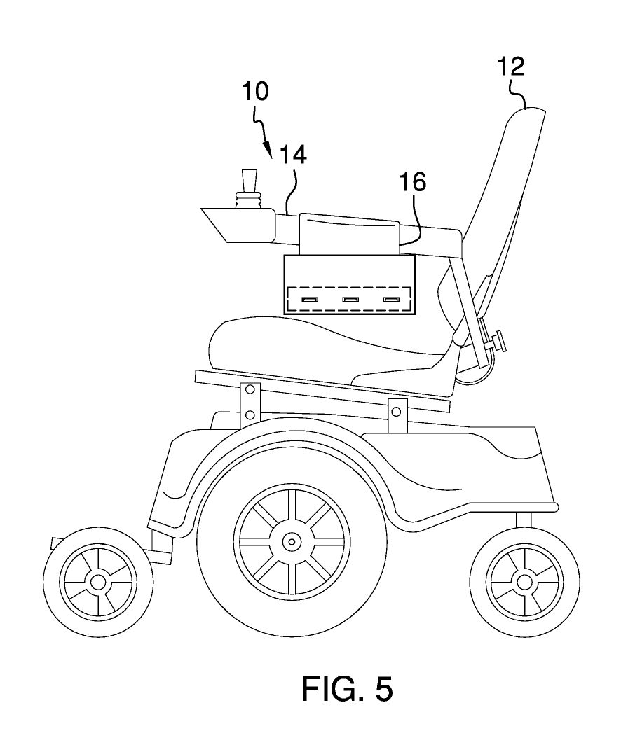

With reference now to the drawings, and in particular to FIGS. 1 through 5 thereof, a new power supply device embodying the principles and concepts of an embodiment of the disclosure and generally designated by the reference numeral 10 will be described.

As best illustrated in FIGS. 1 through 5, the wheelchair power supply system 10 generally comprises an electric wheelchair 12 that has an armrest 14. A pouch 16 is provided and the pouch 16 is suspended from the armrest 14. The pouch 16 has a plurality of apertures 18 extending into an interior of the pouch 16. The pouch 16 has a bottom wall 20 and a perimeter wall 22 extending upwardly therefrom and the perimeter wall 22 has a distal edge 24 with respect to the bottom wall 20 defining an opening 26 into the pouch 16.

The perimeter wall 22 has a front side 28, a back side 30 and a first lateral side 32. The back side 30 extends beyond the distal edge 24 with respect to the front side 28 and the first lateral side 32. Additionally, the back side 30 is curled over onto itself to define a channel 34 and the channel 34 insertably receives the armrest 14. The plurality of apertures 18 includes a first aperture 36 being positioned on the first lateral side 32. Additionally, the plurality of apertures 18 includes a set of second apertures 38 being positioned on the front side 28.

A power supply 40 is included and the power supply 40 is positioned in the pouch 16. The power supply 40 has a charge port 42 and a plurality of outputs 44. Each of the charge port 42 and the outputs 44 may comprise a usb port or the like. A charge cord 46 is provided and the charge cord 46 has a first plug 48 and a second plug 50. The first plug 48 is selectively plugged into the charge port 42 and the second plug 50 is selectively plugged into a power source, such as a female electrical outlet, to charge the power supply 40.

A first power cord 52 is provided and the first power cord 52 has a first plug 54 and a second plug 56. The first plug 54 on the first power cord 52 is selectively plugged into a selected one of the outputs 44. The second plug 56 on the first power cord 52 comprises an electrical plug that is matable to a power cord on the electric wheelchair 12. Additionally, the second plug 56 on the first power cord 52 is selectively electrically coupled to the electric wheelchair 12. In this way the power supply 40 serves as a backup power source for the electric wheelchair 12. Additionally, each of the outputs 44 may have an electronic device electrically coupled thereto for charging.

A second power cord 58 is provided and the second power cord 58 has a first plug 60 and a second plug 62. The first plug 60 on the second power cord 58 may be matable to the second plug 56 on the first power cord 52. The second plug 62 on the second power cord 58 may comprise a cigarette lighter adapter or the like. The first power cord 52 and the second power cord 58 may be used in tandem to charge the electric wheelchair 12 from a cigarette lighter or the like. The power supply 40 comprises at least one rechargeable battery. The charge port 42 is aligned with the first aperture 36 when the power supply 40 is positioned in the pouch 16. Each of the outputs 44 is aligned with an associated one of the second apertures 38 when the power supply 40 is positioned in the pouch 16.

In use, the pouch 16 is suspended from the armrest 14 and the power supply 40 is positioned in the pouch 16. The electric wheelchair 12 is selectively electrically coupled to the power supply 40 when the electric wheelchair 12 loses power. In this way the power supply 40 serves as a backup power source for the electric wheelchair 12. Additionally, the electronic device may be charged with the power supply 40. The second cord and the third cord are used together to facilitate the electric wheelchair 12 to be charged from a cigarette lighter in a vehicle or the like.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wheelchair power supply system comprising:
an electric wheelchair having an armrest;
a pouch being suspended from said armrest, said pouch having a plurality of apertures extending into an interior of said pouch; and
a power supply being positioned in said pouch, said power supply having a charge port for charging said power supply, said power supply having a plurality of outputs, each of said outputs being configured to be electrically coupled to an electronic device for charging, said electric wheelchair being selectively and electrically coupled to one of said outputs such that said power supply serves as a backup power source for said electric wheelchair.

2. The system according to claim 1, wherein said pouch has a bottom wall and a perimeter wall extending upwardly therefrom, said perimeter wall having a distal edge with respect to said bottom wall defining an opening into said pouch, said perimeter wall having a front side, a back side and a first lateral side, said back side extending beyond the said distal edge with respect to said front side and said first lateral side.

3. The system according to claim 2, wherein said back side is curled over onto itself to define a channel, said channel insertably receiving said armrest.

4. The system according to claim 2, wherein said plurality of apertures includes a first aperture being positioned on said first lateral side, said plurality of apertures including a set of second apertures being positioned on said front side.

5. The system according to claim 1, wherein:
said plurality of apertures includes a first aperture and a set of second apertures; and
said power supply comprises at least one rechargeable battery, said charge port being aligned with said first aperture when said power supply is positioned in said pouch, each of said outputs being aligned with an associated one of said second apertures when said power supply is positioned in said pouch.

6. A wheelchair power supply system comprising:
an electric wheelchair having an armrest;
a pouch being suspended from said armrest, said pouch having a plurality of apertures extending into an interior of said pouch, said pouch having a bottom wall and a perimeter wall extending upwardly therefrom, said perimeter wall having a distal edge with respect to said bottom wall defining an opening into said pouch, said perimeter wall having a front side, a back side and a first lateral side, said back side extending beyond the said distal edge with respect to said front side and said first lateral side, said back side being curled over onto itself to define a channel, said channel insertably receiving said armrest, said plurality of apertures including a first aperture being positioned on said first lateral side, said plurality of apertures including a set of second apertures being positioned on said front side; and
a power supply being positioned in said pouch, said power supply having a charge port for charging said power supply, said power supply having a plurality of outputs, each of said outputs being configured to be electrically coupled to an electronic device for charging, said electric wheelchair being selectively and electrically coupled to one of said outputs such that said power supply serves as a backup power source for said electric wheelchair, said power supply comprising at least one rechargeable battery, said charge port being aligned with said first aperture when said power supply is positioned in said pouch, each of said outputs being aligned with an associated one of said second apertures when said power supply is positioned in said pouch.
